(19) United States
(12) Patent Application Publication
(10) Pub. No.: US 2008/0163274 A1
(43) Pub. Date: Jul. 3, 2008

(54) OPTICAL DISC APPARATUS

(75) Inventor: Naoki Eguchi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/960,043

(22) Filed: Dec. 19, 2007

(30) Foreign Application Priority Data
Dec. 27, 2006 (JP) 2006-353419

(51) Int. Cl. G11B 17/04

(52) U.S. Cl. 720/623

(57) ABSTRACT

According to one embodiment, a slot-in type optical disc drive, in which a shutter member can prevent the insertion of an optical disc so that the optical disc already inserted may be played back, and can protect the data surface (data-recording surface) of the optical disc from damage even if the optical disc vibrates due to background vibration.

### CROSS-REFERENCE TO RELATED APPLICATIONS

This application is based upon and claims the benefit of priority from Japanese Patent Application No. 2006-353419, filed Dec. 27, 2006, the entire contents of which are incorporated herein by reference.

### BACKGROUND

1. Field

One embodiment of the invention relates to an optical disc apparatus that can read data from a disc recording medium, such as an optical disc, and can write data to the optical disc.

2. Description of the Related Art

Optical disc apparatuses (optical disc drives) have long been in practical use, each configured to apply a laser beam to an optical disc, thereby reproducing data from the optical disc and recording data on the optical disc.

The optical disc drive includes an optical pickup (optical head) device, a loading mechanism, a disc motor, and a control circuit. The optical pickup is moved radially across the data-recording surface of an optical disc. While being so moved, the optical pickup can read data from and write data to the optical disc. The loading mechanism is configured to load an optical disc to a prescribed position (in the optical disc drive) and to eject the disc reliably from the optical disc drive. The disc motor rotates the optical disc. The control circuit performs miscellaneous control to record data on and reproduce data from the optical disc.

The slot-in type loading mechanism can serve to reduce the thickness of the optical disc apparatus. Further, it is widely used in built-in type optical disc apparatuses for use in car audio-video systems, portable personal computers and the like.

Japanese Patent Application Publication (KOKAI) No. 2000-40350 discloses a disc apparatus in which the drive unit that is opposed to the optical disc mounted on the turntable has a plurality of collision-restricting members. The collision-restricting members extend at right angles or a prescribed angle to the edge of the optical disc. They contact the optical disc when the disc apparatus receives an excessive impact and the optical disc is flexed.

Japanese Patent Application Publication (KOKAI) No. 2002-93143 discloses a slot-in type disc apparatus in which the distal end of a guide pin that transports an optical disc toward the damper is tapered, forming a truncated cone. When the optical disc is greatly vibrated, its outer circumferential edge contacts the distal end of the guide before it abuts on an end of the bottom chassis. The signal-recording surface of the optical disc is thereby protected.

In the Japanese Patent Application Publication 2000-40350, a collision-restricting member (protective member) is provided on the housing, the mechanical base, or the like. Of the protective members, those located near the disc slot cannot be positioned too close to the edge of the disc in order to provide a clearance for the passage of the disc. Consequently, these protective members may inevitably fail to protect the signal-recording surface of the optical disc at the disc slot and in the vicinity thereof.

In the optical disc drive disclosed in Japanese Patent Application Publication 2002-93143, the guide pin is integrally formed with a component that transports and positions an optical disc. Inevitably, the optical disc may be greatly vibrated. In addition, the guide pin cannot be arranged at the center of the disc slot, where it could most effectively restrict the vibration of the disc.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an optical disc apparatus according to an embodiment of the present invention;

FIG. 2 is a diagram showing the configuration of the disc-insertion part of the optical disc apparatus shown in FIG. 1;

FIGS. 3A and 3B are diagrams of the optical disc apparatus shown in FIG. 1, each explaining in detail how an optical disc is inserted into the optical disc apparatus and what position the cam slider takes while the optical disc is being inserted;

FIG. 4 is a diagram of the optical disc apparatus shown in FIG. 1, depicting an optical disc inserted in the optical disc apparatus and remaining in a rotatable state (because the loading arm and the disc holding lever stays at the standby position);

FIG. 5 is a diagram explaining how the disc guard rib works when an optical disc is loaded into the optical disc apparatus shown in FIGS. 1 and 2 (in the non-loading state);

FIG. 6 is another diagram explaining how the disc guard rib works when an disc is loaded into the optical disc apparatus shown in FIGS. 1 and 2 (in the non-loading state);

FIGS. 7A and 7B are diagrams explaining how the disc guard rib works (in a non-loading state) when an optical disc is loaded into the optical disc apparatus of FIGS. 1, 2, 3A, 3B and 4; and

FIGS. 8A and 8B are diagrams explaining how the disc guard rib works (in a non-loading state) when an optical disc is loaded into the optical disc apparatus of FIGS. 1, 2, 3A, 3B and 4.

### DETAILED DESCRIPTION

Various embodiments according to the invention will be described hereinafter with reference to the accompanying drawings. In general, according to one embodiment of the invention, an optical disc apparatus comprising: a disc motor which has a shaft and a turntable secured to the shaft and designed to hold a disc-shaped recording medium and which is configured to rotate the recording medium held by the turntable, at a predetermined speed in a plane parallel to a surface of the recording medium; a transporting mechanism which guides the recording medium to the turntable of the disc motor; a motor which generates a drive force for driving the transporting mechanism; a reciprocating mechanism which transmits the drive force from the motor to the transporting mechanism; and a guide member which is rotated by the reciprocating means around a rotation axis, thereby to protect a recording surface of the recording medium guided to the turntable by the transporting mechanism.

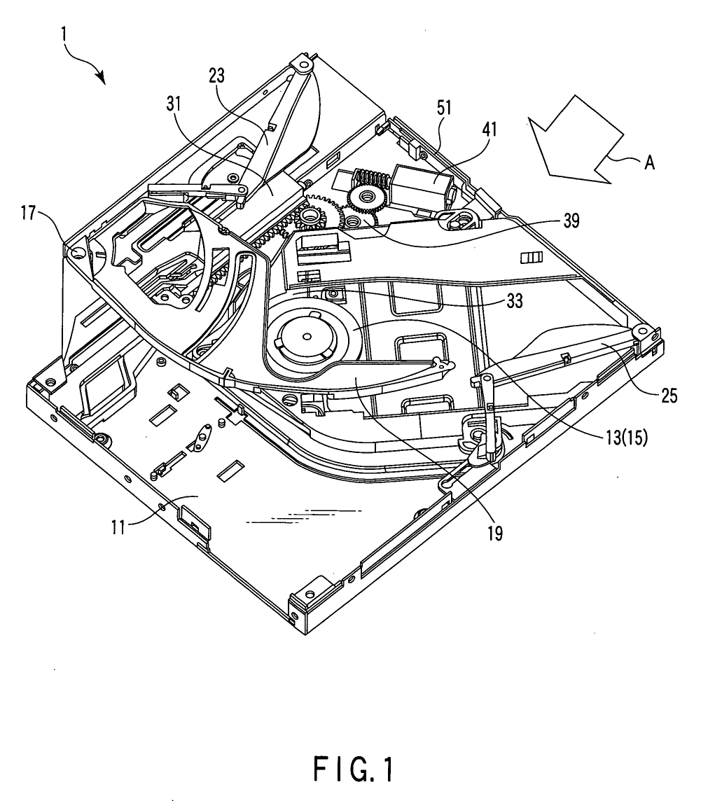

FIG. 1 shows an example of an optical disc apparatus according to an embodiment of the invention. The optical disc apparatus shown in FIG. 1 is a so-called slot-in type, in which an optical disc is inserted so that data may be recorded in and reproduced from, the optical disc. The optical disc apparatus is designed for use in, for example, portable personal computers (notebook PCs). FIG. 1 shows the optical disc apparatus, with some parts of the housing having been removed.

As shown in FIG. 1, the optical disc apparatus 1 has a bottom cover, i.e., mechanical base chassis 11 and a disc motor 13 mounted on the center of the mechanical base chassis 11. On the shaft (not shown) of the disc motor 13, a turntable 15 is mounted to hold an optical disc.

Near the turntable 15, a loading arm 19 is provided. The loading arm 19 can rotate around a fulcrum 17 that is provided at a prescribed position on the mechanical base chassis 11.

A first disc guide 23 and a second disc guide 25 are provided on two opposing edges of the mechanical base chassis 11, respectively. (In other words, the first disc guide 23 and the second disc guide 25 are located on the right and left of the turn table 15, respectively, as viewed in the direction of arrow A.) The first disc guide 23 and the second disc guide 25 cooperate with the loading arm 19 to support an optical disc being inserted in the direction of arrow A and to guide the optical disc to the loading arm 19. The first and second disc guides 23 and 25 oppose each other across the turntable 15. Thus, the turntable 15 lies between the guides 23 and 25, as viewed in a direction parallel to the shaft of the disc motor 13 that supports the turntable 15.

A disc holding lever (not shown in FIG. 1) is provided in the vicinity of the first disc guide 23. The disc holding lever cooperates with the loading arm 19 to push an optical disc inserted in the direction of arrow A, onto the loading arm 19.

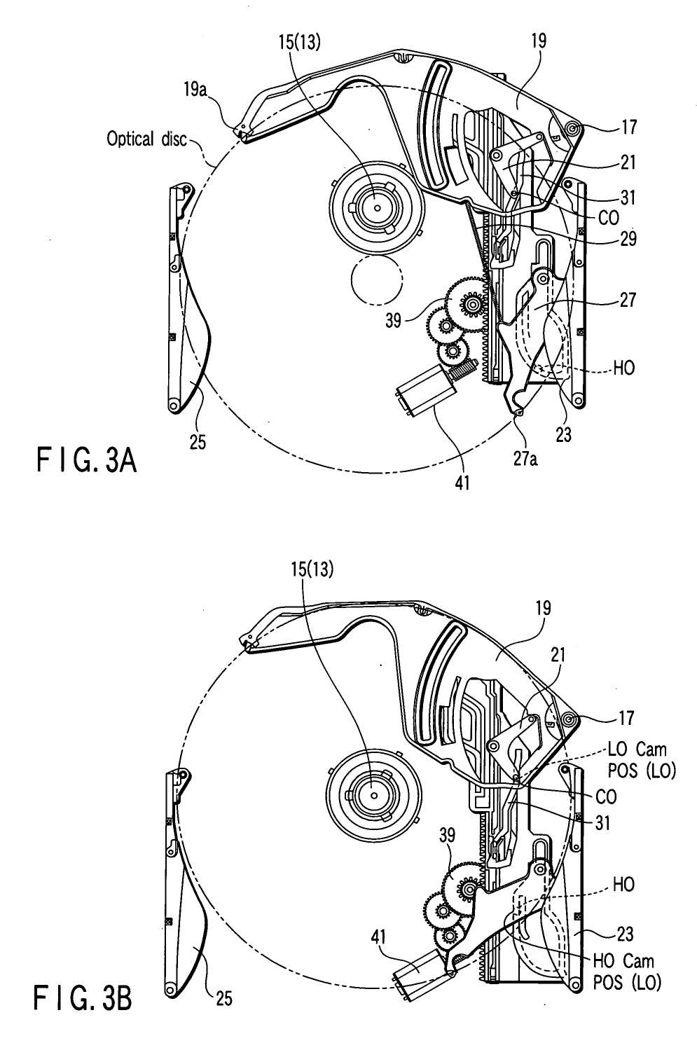

A cam slider 31 can move back and forth in a direction parallel to the direction of arrow A. A connecting cam (not shown) converts the reciprocation of the cam slider 31 to the rotation of the loading arm 19 and the disc holding lever. As a result, the loading arm 19 and the disc holding lever clamp the optical disc inserted into the optical disc apparatus 1 and transport the disc until the center hole of the optical disc comes into axial alignment with the turntable 15, as will be explained later with reference to FIGS. 3A and 3B.

The cam slider 31 can move in parallel in the mechanical base chassis 11 as shown in FIGS. 3A and 3B, because the forward or inverse rotation of a loading motor 41 is transmitted to the cam slider 31 by a series of gears 39.

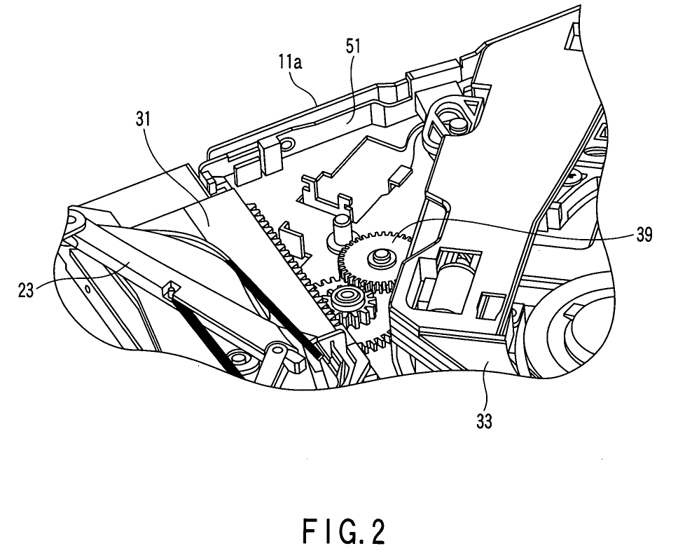

As shown in the magnified view of FIG. 2, a disc guard rib 51 is provided on the disc-slot side of the optical disc apparatus 1. The disc guard rib 51 moves in unison with the reciprocation of the cam slider 31.

As explained with reference to FIG. 1, the optical disc apparatus 1 is a slot-in type. Therefore, the apparatus 1 performs a loading operation to transport an optical disc to the housing, and an ejecting operation to eject the optical disc from the housing. In most cases, the disc motor 13 remains off the path along which the optical disc moves, until the optical disc is guided to a prescribed position (clamping position), and similarly until the optical disc is ejected from the optical disc apparatus 1.

To keep the disc motor 13 off the path along which the optical disc moves, the housing (motor case) of the disc motor 13 and the mechanical base chassis 11 of the optical disc apparatus 1 are appropriately designed so that the disc motor 13 as a whole may be rotated around its shaft. The disc motor 13 can therefore approach, for example, the mechanical base chassis 11 and hence moves away from the path along which the optical disc moves.

How the cam slider 31 moves back and forth, causing the disc holding lever to transport the optical disc, will be explained with reference to FIGS. 3A and 3B.

As shown in FIG. 3A, an optical disc is inserted (or pushed) into the optical disc apparatus 1 in the direction of arrow A. The outer circumference of the optical disc eventually contacts the disc holding pin 27a of the disc holding lever 27 at a given position. The optical disc is then guided toward the loading arm 19 and the turntable 15 and contacts the first positioning projection 19a of the loading arm 19. A spring 29 exerts a predetermined tension on the disc holding lever 27 and loading arm 19, pulling the disc holding lever 27 and loading arm 19 toward the turntable 15. The optical disc is therefore guided to the turntable 15, while being supported by the disc holding lever 27 and the loading arm 19.

As the optical disc is further pushed, the loading arm 19 rotates around the fulcrum 17, moving away from the turntable 15. As the optical disc is inserted still further into the optical disc apparatus 1 (or as the loading arm 19 is rotated), the first disc guide 23 and the second disc guide 25 are gradually moved outwards, preventing the optical disc from moving in any undesirable manner.

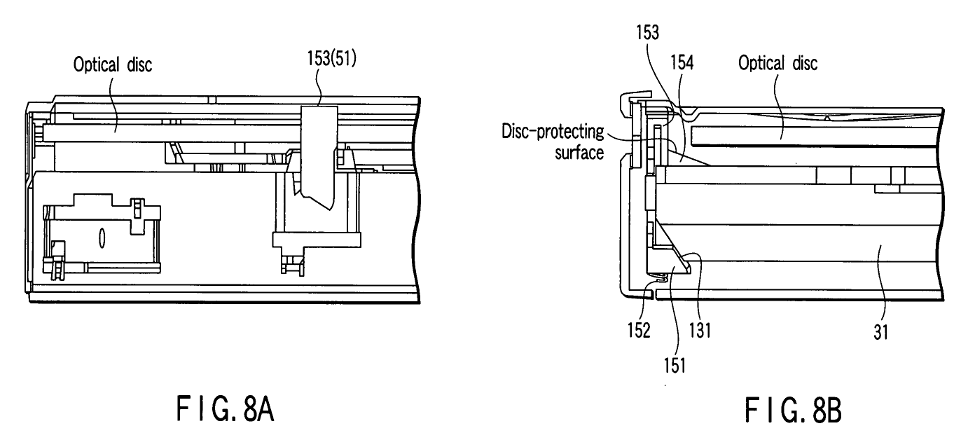

As the optical disc is pushed deeper into the apparatus 1, the fulcrums 23a and 25a of the first and second disc guides 23 and 25, respectively, are moved their outermost positions as shown in FIG. 8A. As a result, the disc holding lever 27 and the loading arm 19 transport the optical disc until the center of the optical disc reaches a position near the turntable 15.

As the disc holding lever 27 and the loading arm 19 are rotated, the optical disc held by the disc holding lever 27 and loading arm 19 is further transported until its center aligns with the center of the turntable 15 as shown in FIG. 3B.

As the cam slider 31 further slides, the engagement projection CO of a connection lever 21 enters an LO cam POS (LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 27 enters an HO cam POS (LO). Then, the disc holding pin 27a moves, pushing the optical disc until the center of the disc aligns with the center of the turntable 15. The optical disc is thereby set at a prescribed position on the turntable 15, where it should be clamped.

In order to rotate the optical disc, a spring-force releasing mechanism (not shown) releases the disc holding lever 27 and the loading arm 19 from the tension that biases them toward the turntable 15. Thus, the disc holding lever 27 and the loading arm 19 are inhibited from contacting the outer circumference of the optical disc.

A pickup head (PUH) (not shown) is incorporated in a sub-chassis 33 and can be moved in the radial direction of the optical disc. As the PUH is so moved, it reads data from the optical disc or records data in the optical disc, as has been reported in many prior art references. Hence, it will not be explained how the PUH reads data or records data.

In order to eject the optical disc, the loading arm 19 is rotated in the opposite direction (to move the optical disc to the disc-ejecting position). The optical disc can therefore be ejected with ease.

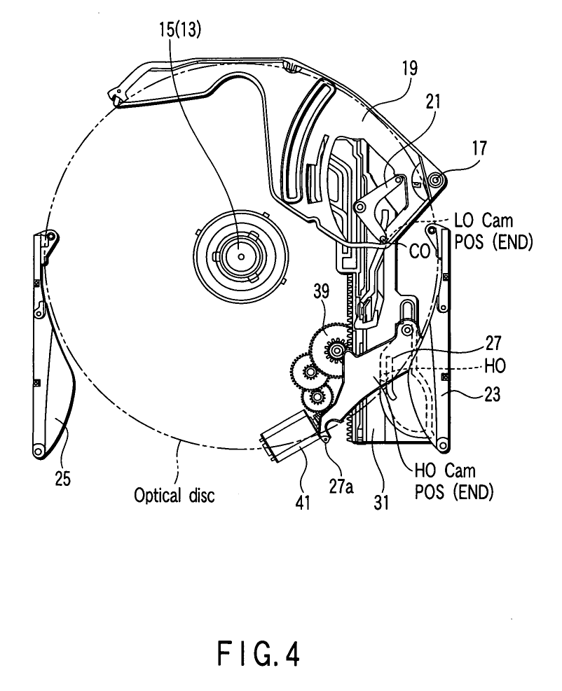

As seen from FIG. 1, FIG. 2, FIGS. 3A and 3B and FIG. 4, the end of the cam slider 31 that is remote from the disc slot lies deeper than the fulcrum 17 in the mechanical base chassis 11 while the cam slider 31 remains at the standby position. At the time the optical disc is completely loaded as shown in FIG. 2, the cam slider 31 has already moved to a position near that end 11a of the mechanical base chassis 11, which is close to the disc slot. (This moving of the cam slider 31 can be understood if the positions the loading motor 41 takes in FIGS. 3A and 3B are compared with each other.

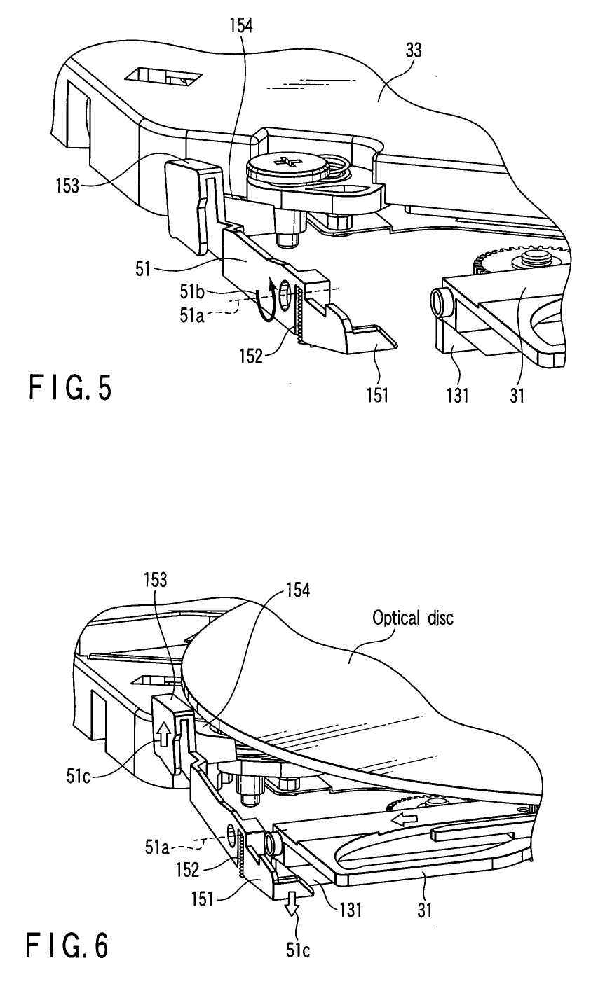

How the disc guard rib works as the cam slider moves back and forth will be explained, with reference to FIGS. 5 and 6.

As shown in FIG. 1 the slot-in type optical disc apparatus 1 needs to have a sufficiently large space in the vicinity of the disc slot as it serves as a path through which the optical disc is transported.

Most slot-in type optical disc apparatuses have a shutter member (hereinafter referred to as shutter lever) which operates when the loading of an optical disc is completed and which keeps the disc slot closed while the apparatus is operating (while an optical disc remains inserted in the apparatus).

In the optical disc apparatus 1 according to this invention, a shutter lever 153 is integrally formed with the disc guard rib 51 as illustrated in FIG. 5. The shutter lever 153 is rotated around the rotation axis 51a of the disc guard rib 51, in the direction of arrow 51b, when an optical disc is inserted into and ejected from the optical disc apparatus 1.

A path along which the optical disc moves is thereby provided. While the apparatus 1 is operating (while the optical disc remains inserted in the apparatus 1), the shutter lever 153 is rotated around the rotation axis 51a of the disc guard rib 51, in the direction of arrow 51c, i.e., the direction opposite to the direction of arrow 51b. In this case, the shutter lever 153 prevents the insertion of any other optical disc. The disc guard rib 51 is biased in the direction of arrow 51b by a compression spring 152 while it remains at the standby position (or in a non-loading state). Therefore, the disc guard rib 51 need not be released at the start of the disc insertion.

The shutter lever 153 (i.e., disc guard rib 51) has a pressure-receiving end 151 that can engage with the pressure-applying end 131 of the cam slider 31. At the end of the loading described with reference to FIGS. 3A and 3B and FIG. 4 (i.e., loading END), the cam slider 31 is moved to the disc slot 11a. At this point, the pressure-applying end 131 of the cam slider 31 applies a force to the pressure-receiving end 151 of the shutter lever 153. Since this force acts in the direction of arrow 51c, the shutter lever 153 is rotated to the operating position shown in FIG. 6.

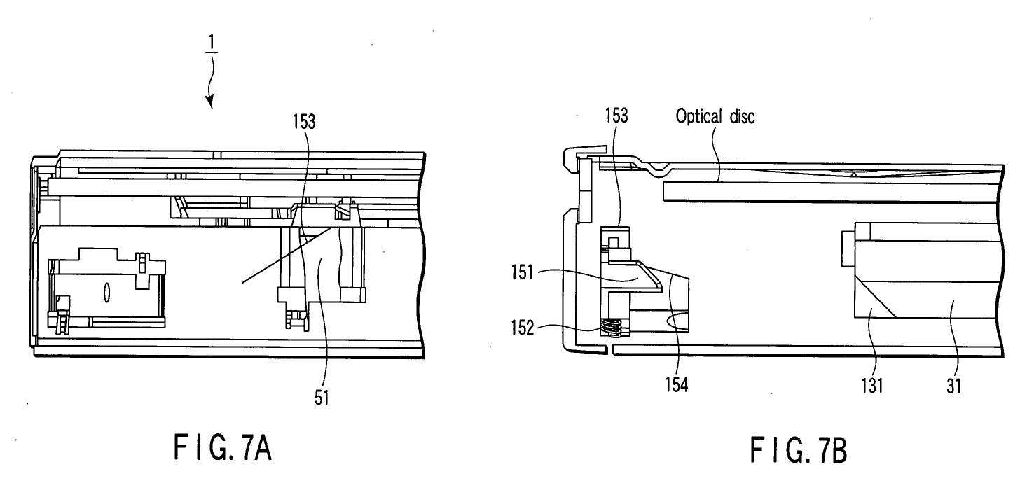

The shutter lever 153, i.e., disc guard rib 51, has a disc-protecting surface 154 on the side opposed to the disc motor 13, as schematically illustrated in FIGS. 7A and 7B and FIGS. 8A and 8B. The disc-protecting surface 154 can contact the edge (i.e., outer circumferential edge) of the optical disc clamped to the turntable 15 and rotated.

That is, the shutter lever 153, i.e., the distal end of the shutter member, is spaced from the outer circumference of the optical disc by an appropriate distance. A positioning projection is thus provided, which can restrict the vibration, if any, of the optical disc. This projection has a sloping surface, i.e., disc-protecting surface 154. The disc-protecting surface 154 can guide the outer circumferential edge of the optical disc even if the disc receives background vibration. This protects the data-recording surface of the optical disc from damage.

Needless to say, the cam slider 31 can of course move back and forth as the forward or inverse rotation of a loading motor 41 is transmitted to the cam slider 31 by a series of gears.

As has been described, in a slot-in type optical disc apparatus according to an embodiment of this invention, a shutter member prevents an erroneous insertion of another optical disc so that the optical disc already inserted can be played back. Therefore, the shutter member can protect the data-recording surface of the optical disc even if the disc clamped on the turntable vibrates due to background vibration while data is being reproduced from it or recorded in it. That is, the data-recording surface of the optical disc can be easily protected, without using any additional or dedicated members. Thus, a slot-in type optical disc apparatus can be provided, in which a path can be formed for the optical disc being transported and the data-recording surface of the optical disc can be protected from damage while data is being reproduced from or recorded in the optical disc.

Moreover, in the slot-in type optical disc apparatus according to an embodiment of this invention, a shutter member for preventing an erroneous insertion of another optical disc so that the optical disc already inserted can be played back is used, thereby protecting the data-recording surface of the optical disc even if the disc vibrates due to background vibration while data is being reproduced from it or recorded in it.

Further, the shutter member can be moved to an operating position and a standby position, when it is driven by a reciprocating mechanism that is used to load and eject an optical disc into and from the optical disc apparatus. Hence, the shutter member requires no new drive units. An optical disc apparatus of high reliability can therefore be provided at low cost.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a disc motor which has a shaft and a turntable secured to the shaft and designed to hold a disc-shaped recording medium and which is configured to rotate the recording medium held by the turntable, at a predetermined speed in a plane parallel to a surface of the recording medium;
a transporting mechanism which guides the recording medium to the turntable of the disc motor;
a motor which generates a drive force for driving the transporting mechanism;
a reciprocating mechanism which transmits the drive force from the motor to the transporting mechanism; and
a guide member which is rotated by the reciprocating means around a rotation axis, thereby to protect a recording surface of the recording medium guided to the turntable by the transporting mechanism.

2. The apparatus according to claim 1, wherein the guide member is able to prevent insertion of another recording medium after the transporting mechanism has transported the recording medium into the apparatus and after the reciprocating mechanism has reached a transport-end position.

3. The apparatus according to claim 1, wherein the guide member has a sloping surface which limits vibration of the recording medium transported into the apparatus by the transporting mechanism, to a predetermined value.

4. The apparatus according to claim 1, wherein the guide member has a sloping surface which limits vibration of the recording medium transported into the apparatus by the transporting mechanism, to a predetermined value.

5. An optical disc apparatus comprising:
a main chassis which includes a flat part having a prescribed size;
a disc motor which is positioned at a substantially central part of the main chassis and which is configured to rotate a disc-shaped recording medium around a rotation axis that extends at right angles to a plane of the recording medium;
a disc holding mechanism which applies a force to the recording medium inserted in an insertion slot provided at one end of the main chassis, the force biasing the recording medium toward the disc motor;
a transporting mechanism which cooperates with the disc holding mechanism to hold the recording medium inserted in the insertion slot provided at one end of the main chassis and which transports the recording medium toward the disc motor;
a loading motor which generates a drive force for driving the disc holding mechanism and the transporting mechanism;
a sliding member which transmits the drive force from the loading motor to the disc holding mechanism and the transporting mechanism; and
a shutter member which is rotated around a preset rotation axis when the sliding member reaches a prescribed position, thereby to protect a recording surface of the recording medium transported to the disc motor by the disc holding mechanism and the transporting mechanism and to prevent another recording medium from being inserted into the insertion slot of the main chassis.

6. The apparatus according to claim 5, wherein the shutter member has a sloping surface inside the insertion slot of the main chassis, the sloping surface limiting vibration of the recording medium transported into the apparatus by the transporting mechanism, to a predetermined value.

7. The apparatus according to claim 5, wherein the shutter member has a sloping surface which contacts an outer circumferential edge of the recording medium guided by the disc motor and lying inside the insertion slot of the main chassis, thereby to limit the vibration of the recording medium to a predetermined value, the vibration generated as the recording medium is rotated at a predetermined speed in a plane parallel to a surface of the recording medium.

8. An optical disc apparatus comprising:
a chassis which has a flat part having a prescribed size;
a motor which is provided at a prescribed position on the chassis and which has a shaft and a turntable secured to the shaft and designed to hold and rotate a disc-shaped medium around a rotation axis;
an insertion slot which is made at one end of the chassis and through which the disc-shaped medium is inserted toward the turntable and ejected from the apparatus; and
a shutter member which is provided at a prescribed position of the insertion slot and configured to move into a path for guiding the disc-shaped medium, and which moves into the insertion slot when the disc-shaped medium is chucked to the turntable, thereby to prevent another disc-shaped medium from being inserted into the insertion slot and limit vibration of the disc-shaped medium being rotated.

9. The apparatus according to claim 8, wherein the shutter member rotates around a rotation axis that extends at right angles to the flat part of the chassis and is moved into the insertion port as a transporting mechanism operates, transporting the disc-shaped medium toward the motor.
